(19) United States
(12) Patent Application Publication
(10) Pub. No.: US 2012/0151606 A1
(43) Pub. Date: Jun. 14, 2012

(54) SOFTWARE SYSTEM FOR DENYING REMOTE ACCESS TO COMPUTER CAMERAS

(76) Inventor: James Hannon, Santa Monica, CA (US)

(21) Appl. No.: 12/964,585

(22) Filed: Dec. 9, 2010

(51) Int. Cl. G06F 21/00

(52) U.S. Cl. 726/29

(57) ABSTRACT

A program and method for detecting and preventing the unauthorized remote access of a computer camera by determining whether the camera is activated, and scanning applications to determine if the activation is authorized, and if it is not authorized, then the user is alerted.

### FIELD OF THE INVENTION

The present invention relates to a software for computer security; more specifically, it relates to a program and method for detecting and preventing unauthorized remote access of computer cameras.

### BACKGROUND OF THE INVENTION

The present invention is a software program designed to block unauthorized access to a computer's camera, commonly known as a webcam, to prevent hacking or spyware from remotely activating the webcam for illicit purposes.

A webcam is a video capture device that is connected to a computer. In the past, a webcam was simply a digital camera connected to the computer, usually through a Universal Serial Bus (USB) port. Nowadays most desktop computers and laptops have built-in webcams. A webcam operates by employing software that enables the computer to broadcast images taken by the webcam over an Internet connection to a remote viewing location. Because of its ability to transmit live images and video, webcams can be used for a variety of purposes. For example, a webcam can be used for security surveillance, such as to monitor one's house while on vacation. Or it can be used as a “nanny cam” to monitor and supervise the activities of caregivers in a home. In addition to surveillance, webcams are also commonly used for video conferencing in business and education. And with recent developments in technology, webcams are now popularly used for private chatting in real time.

But with the exploding popularity and ubiquity of webcams, now that they can be found everywhere from bedrooms to boardrooms, webcams have become inviting targets for hackers, who have figuratively and literally turned webcams on the host users themselves. In recent years, there have been widely reported incidents of hackers using malicious software programs (“malware) to covertly take control of webcams to spy on unsuspecting victims. A webcam can be hijacked without the user's knowledge or consent in a number of ways.

Most commonly, a computer can be attacked by worms, malware, spyware, and Trojan agents. In particular, webcams can be hacked via emails containing malicious files that break into the computer and take over control of the webcam. In one widely reported instance, a hacker used a Trojan horse spyware to gain remote control of a webcam to take surreptitious pictures of an unsuspecting victim in her bedroom.

A hacker can also attempt to break into a computer by “port-scanning,” in which a series of messages are sent to determine the port number of the webcam. Because webcams are connected to the Internet, with many such cameras running on default configurations that do not require any password login or IP address verification, making them visible to anyone, hackers can often find private webcams and connect to them through the Internet.

The loss of privacy due to the hijacking of webcams presents a serious security problem. Yet there have been few effective solutions specifically targeted to preventing webcam spying. One solution has been to provide webcams with lens covers. For example, U.S. Patent Application Publication No. 2010/0102979 to Huang et al. teaches a lid that can move to shield the image capture module. However, such a device is ineffective because it can be inadvertently left open. Alternatively, some webcams have built-in hardwired LED indicators that light up whenever the webcam is active. This, too, is ineffective because such indicators not only can be easily overlooked, they do not distinguish between authorized and unauthorized activation of the webcam.

For network computers, the conventional solution to prevent hacking has been to build firewalls as general defenses. Firewalls are typically set up as a perimeter defense to protect networked computers from intentional hostile intrusion by generally blocking unauthorized access to a computer system while permitting authorized access. For example, messages entering or leaving a network pass through a firewall, which inspects each message and blocks those that do not meet the specified security criteria. However, firewalls are generally not integrated into portable computers, and firewalls can be expensive and difficult to implement. Moreover, they can be ineffective because once a break-in occurs, the computer is already compromised and the malicious program controlling the computer can disable the personal firewall.

Accordingly, there is a need for a more effective security system that specifically protects a computer's webcam without the need to establish a firewall.

### SUMMARY OF THE INVENTION

It is an object of the invention to provide a security system that specifically protects the webcam and related peripheral devices.

It is an object of the invention to provide a security system to automatically detect any unauthorized activation of the webcam.

It is an object of the invention to provide a security system to alert the host user of any unauthorized activation of the webcam.

According to the objects of the invention, the software of the present invention comprises the steps of selecting a webcam, determining if the webcam is activated, then determining if the activation is authorized, and if the activation is not authorized then the user is alerted by a prompt that enables the user to either permit or deny access to the webcam.

In a Microsoft Windows operating system for example, the software enumerates possible video capture devices present in the computer. Once a list of video capture devices is determined, the webcam is checked by previewing its video. Video is previewed to determine if the webcam is activated. If video is capable of being previewed by the software of the present invention, then it will be recognized that the only application using the webcam is the software. If the webcam video is unable to be previewed, then it will be recognized that some other application is using the webcam.

If it is recognized that the webcam is used by an unauthorized application because video from the webcam cannot be previewed, then a list of processes and modules are scanned to determine the identifier of the process. The list of processes is the list of applications currently running on the operating system. Each process or application can have different modules or dynamic-link libraries running under the same application (process). The scanning is done by enumerating all the current processes in the system. It is conducted to look for the presence of the application programming interface, which is a media-streaming architecture of the operating system. Using the application programming interface, the application can perform video and audio playback or capture.

Once the identifier is determined to be from an unauthorized source, the host user is prompted to deactivate the webcam.

### BRIEF DESCRIPTION OF THE DRAWINGS

FIG. 1 is a schematic of a computer system.

FIG. 2 is a block diagram of the computer system

FIG. 3 is a block diagram of the methods of according to an embodiment of the invention.

FIG. 4 is a block diagram of the methods according to another embodiment of the invention.

### DETAILED DESCRIPTION OF THE INVENTION

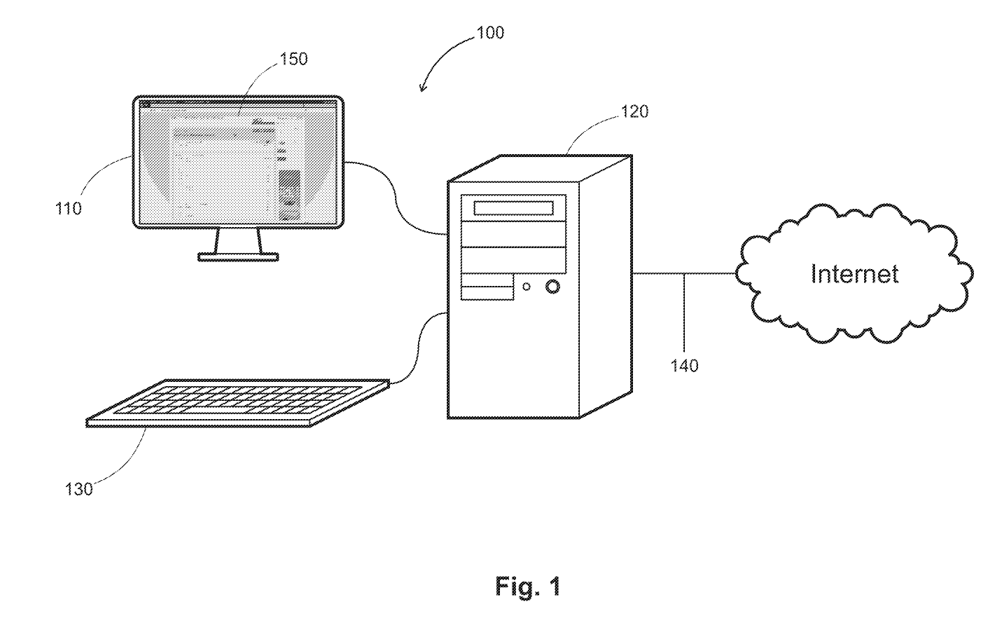

FIG. 1 is a schematic of a computer system 100 suitable for use with the present invention, having a screen display 110, a central processing unit 120, an input device (keyboard) 130, an Internet connection 140, and a webcam 150. The webcam 150 is connected to the Internet through connection 140.

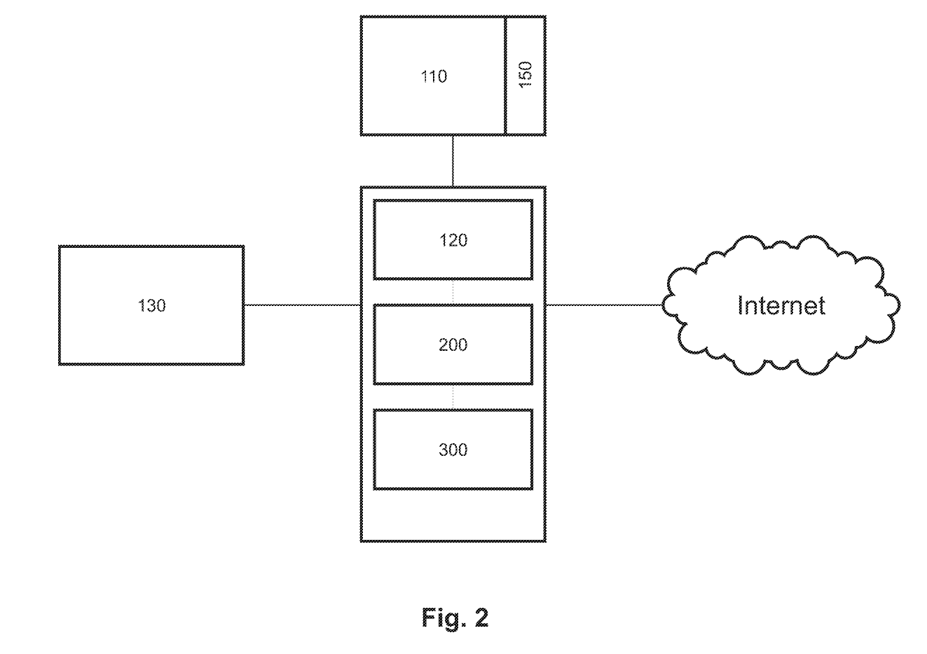

The central processing unit 120 supports and operating system 200. The security software 300 according to the present invention runs on operating system 200 as schematically shown in FIG. 2.

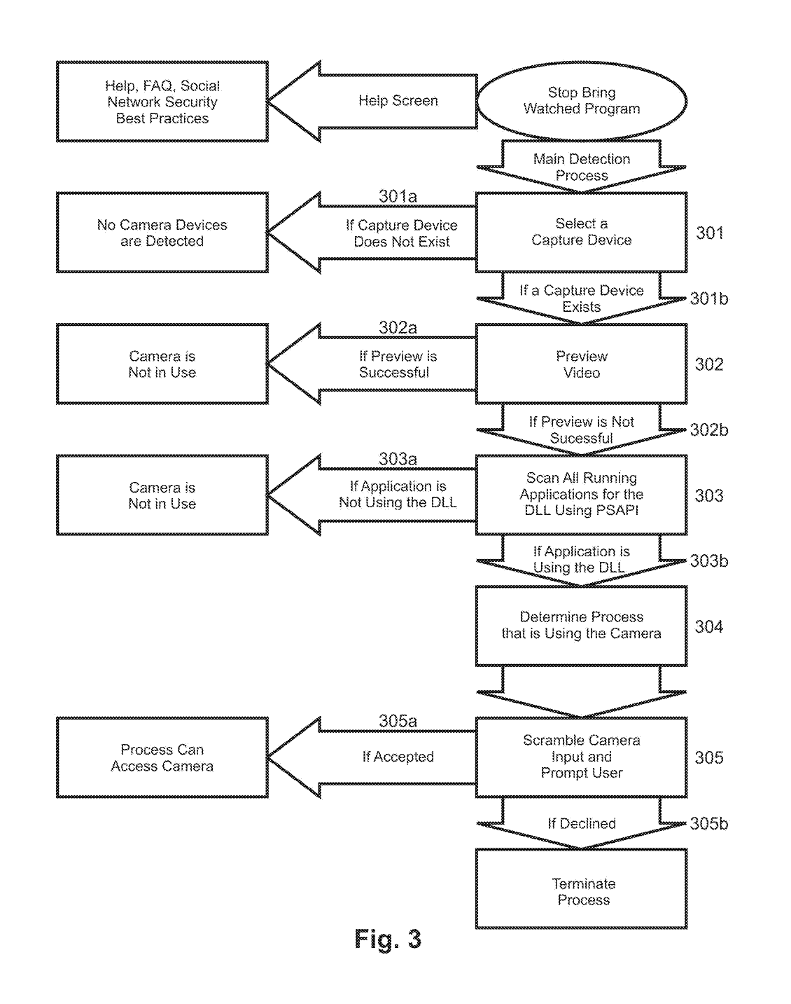

In an embodiment of the present invention, for Microsoft Windows operating system as shown in FIG. 3, the security software 300 according to the present invention comprises the following method. The first step 301 of the method is to select the camera 150 from a set of possible capture devices (not shown). A capture device is one that is used in the recording of an image. In order to select the camera 150, the software enumerates possible video capture devices present in the computer system 100. This is done by enumerating the filters for all video capture devices installed on the computer system 100. A filter is a computer program to process a data stream (i.e. a sequence of data packets used to transmit or receive information that is in transmission). Specifically, it is necessary to locate filters for video. This is done by using a system device enumerator that returns a collection of device monikers for video capture. Video capture describes any application where video is received from a video capture device. A video capture filter has pins that are distinguished by their functionality, which is identified using a pin category. By locating the appropriate video pin, it can be determined if the camera 150 is selected.

Referring again to FIG. 3, if no video capture device is detected pursuant to step 301a, then the method of the present invention concludes as no video capture device exists for the computer system 100. If a camera 150 is detected pursuant to step 301b, then the method continues to step 302.

The next step 302 is to determine whether the selected camera 150 is activated. To determine if the camera 150 is in use, video from the camera 150 is previewed. If the camera video is capable of being previewed by the software 300 of the present invention, then it will be recognized that the only application using the camera 150 is the current software 300. This is because the software 300 would not be able to access the camera 150 and preview its video if the camera 150 is being used by another application. Thus, if video cannot be previewed, then it will be recognized that some other application is using the camera 150. In previewing video, a preview pin is used to render video. If preview is successful pursuant to step 302a, then the camera 150 is not in use, and the method of the program concludes.

On the other hand, if preview is unsuccessful pursuant to step 302b, then the program scans all running applications pursuant to step 303. In step 303, the running applications are scanned according to a predetermined list of dynamic-link libraries, or DLLs, which are libraries of data files that provide the functionality of the programs that nm on the operating system 200. The software 300 determines the application that is using the camera 150 by examining the DLLs in use. If the selected application is not using the DDL pursuant to step 303a, then the camera 150 is not in use by the selected application. If the selected application is using the DDL pursuant to step 303b, then the program will determine the process that is using the camera 150 pursuant to step 304.

Using a process status application programming interface, which is a helper library that makes it easier for users to obtain information about processes and device drivers, process status information can be retrieved. To determine which processes have loaded a particular DLL, it is necessary to enumerate the modules for each process. This is done by retrieving a handle for each module in the specified process in order to enumerate the modules of current processes in the system.

If any application is using one of the listed DLLs, then the program checks if it is one of the known media players. If it is not among the list of known media players, then it can be assumed that it is using the camera 150. Once the process has been discovered, the camera input is scrambled pursuant to step 305 and the user is alerted. The user is prompted to either accept camera access pursuant to step 305a or decline camera access pursuant to step 305b. If the user chooses to decline camera access pursuant to step 305b, the process is terminated and access to camera 150 is blocked.

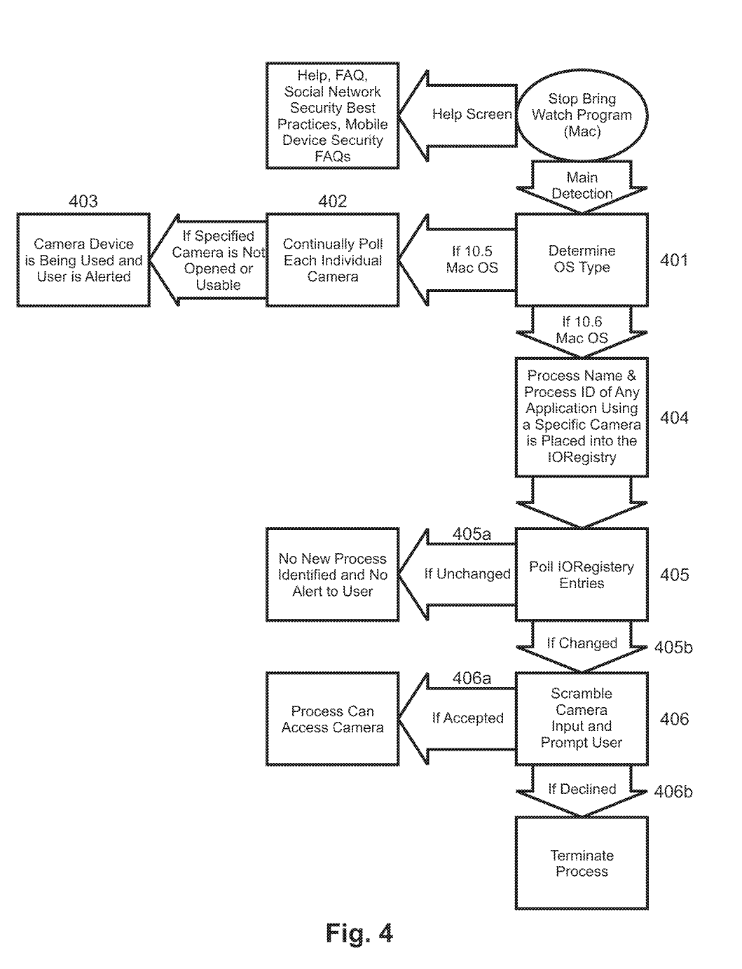

In another embodiment of the present invention, for a Mac OS (the trademarked name for a series of graphical user interface-based operating systems developed by Apple Inc. for their Macintosh line of computer systems) as shown in FIG. 4, the security software 400 according to the present invention comprises the following method. The first step 401 of the method is to determine the particular operating system type. For example, the operating system might be either 10.5 Mac OS or 10.6 Mac OS. For 10.5 Mac OS, the next step 402 is to continually poll any attached camera to determine if it is usable. The camera is usable if video access is available. If the selected camera is determined to be not usable, then it is recognized that the camera is being used and the host user is alerted according to step 403.

For 10.6 Mac OS, the process name and process ID of any application using the selected camera is placed into the I/O Registry pursuant to step 404. The I/O Registry is a dynamic database that records the network of driver objects participating in hardware connections on a Mac OS X system and tracks the provider-client relationships among those objects. As hardware is added to or removed from the system, the I/O Registry changes to accommodate the addition or removal. Thus, it is necessary to poll the I/O Registry entries 405 by scanning it at defined intervals to determine if there are any changes to it. If the I/O Registry is unchanged pursuant to 405a, then it will be recognized that no new process is identified and, therefore, no alert to the user is required. If the I/O Registry is changed pursuant to 405b, then the camera input is scrambled pursuant to step 406 and the user is alerted. The user is prompted to either accept camera access pursuant to step 406a or decline camera access pursuant to step 406b. If the user chooses to decline camera access pursuant to step 406b, the process is terminated and access to camera 150 is blocked.

I claim:

1. A method for detecting unauthorized activation of a video capture device connected to a computer, comprising the steps of:
a) selecting said video capture device from a set of capture devices, wherein:
if no video capture device is detected, then said method concludes; otherwise,
if said video capture device is detected, then said method continues;
b) determining whether said video capture device is activated by previewing video from said video capture device, wherein:
if said preview is successful, then said method concludes; otherwise,
if said preview is not successful, then said method continues;
c) scanning running applications according to a predetermined list of dynamic-link libraries to determine if the activation of said video capture device is by an authorized application, wherein:
if a selected application is not using said dynamic-link libraries, then said method concludes; otherwise,
if a selected application is using said dynamic-link libraries, then said method continues;
d) determining a process that is using said video capture device by retrieving process status information;
e) scrambling said video capture device input;
f) displaying a message prompting a user to permit or deny access to said video capture device, wherein:
if said user permits said access, said process can access said video capture device; otherwise,
if said user denies said access, said process is terminated.

2. A method for detecting unauthorized activation of a video capture device connected to a computer, comprising the steps of:
a) selecting said video capture device from a set of capture devices;
b) determining whether said video capture device is activated by previewing video from said video capture device;
c) scanning running applications according to a predetermined list of dynamic-link libraries to determine if the activation of said video capture device is by an authorized application:
d) determining process that is using said video capture device by retrieving process status information;
e) scrambling said video capture device input;
f) displaying a message to prompt user;
wherein access to said video capture device is terminated if said user declines access.

3. The method of claim 2 further comprising: concluding said method if no video capture device is detected.

4. The method of claim 2 further comprising: continuing said method if said video capture device is detected.

5. The method of claim 2 further comprising: concluding said method if said preview is successful.

6. The method of claim 2 further comprising: continuing said method if said preview is not successful.

7. The method of claim 2 further comprising: concluding said method if a selected application is not using said dynamic-link libraries.

8. The method of claim 2 further comprising: continuing said method if a selected application is using said dynamic-link libraries.

9. The method of claim 2 further comprising: permitting access to said video capture device if said user accepts said access.

10. The method of claim 2 further comprising: terminating access to said video capture device if said user declines said access.

11. A method for detecting unauthorized activation of a video capture device connected to a computer, comprising the steps of polling said video capture device, wherein if said video capture device is not usable, then a message is displayed to alert a user and said method concludes.

12. A method for detecting unauthorized activation of a video capture device connected to a computer, comprising the steps of:
a) placing the process name and process ID of any application using said video capture device into an I/O Registry;
b) polling said I/O Registry, wherein:
if the entries for said I/O Registry is determined to be unchanged, then said method concludes; otherwise,
if the entries for said I/O Registry is determined to be changed, then said method continues;
c) scrambling said video capture device input;
d) displaying a message prompting a user to permit or deny access to said video capture device, wherein:
if said user permits said access, said process can access said video capture device; otherwise,
if said user denies said access, said process is terminated.
